(19) United States
(12) Patent Application Publication
(10) Pub. No.: US 2005/0276443 A1
(43) Pub. Date: Dec. 15, 2005

(54) Method and apparatus for recognizing an object within an image

(76) Inventors: Mohamed Adel Slamani, Alexandria, VA (US); Ahmed A. Slamani, Stafford, VA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 10/855,950

(22) Filed: May 28, 2004

(51) Int. Cl. G06K 9/00

(52) U.S. Cl. 382/103

(57) ABSTRACT

A method and apparatus is described for detecting and recognizing an object within a generated image regardless of the aspect view angle of the object within the image. An object may be recognized by comparing descriptor values determined for the detected object with descriptor values and/or value ranges stored in an information base for different aspect view angles of a plurality of objects. A novel desurfacing approach may be use to remove image surface distortions unrelated to objects within the image. A novel graphical user interface may be used to improve user interaction and control of the object recognition process. The method and apparatus described may be used to detect objects within images generated by a wide variety of imaging systems. For example, concealed explosive devices may be detected by configuring the apparatus to recognize views of a conventional blasting cap's dense explosive filler within x-ray generated images.

### BACKGROUND OF THE INVENTION

1. Field of the Invention

. The present invention pertains to automated detection and recognition of objects. In particular, the present invention pertains to the use of image processing and image analysis techniques to detect and recognize a view of an object within an image.

2. Description of the Related Art

Recent advances in imaging technologies have resulted in the ability to quickly and easily generate images, or imagery data, in support of a wide variety of applications. For example medical imaging technologies such as X-rays, computer aided tomography, and magnetic resonance imaging (MRI) allow high resolution images to be generated of areas deep within the human body without invasive procedures. Further, earth sciences imaging technologies such as ship-board sonar and aircraft/spacecraft based high-resolution radar and multi-spectrum photography may be used to generate detailed images of the ocean floor, areas of agricultural/military significance, as well as detailed surface maps of nearby planets.

Due to recent increases in terrorist activities within the United States and throughout the world, many of these conventional imaging technologies have been adapted and new imaging technologies have been developed for use in concealed weapons detectors (CWD) to detect and locate weapons, explosive devices and other contraband materials concealed upon individuals, within luggage or other closed packages and/or concealed within transport vehicles such as ships, trucks, railway cars and aircraft. For example, new infrared (IR) and millimeterwave (MMW) technologies allow clothing to be safely penetrated to generate images that can reveal weapons, explosives and/or other objects concealed beneath an individual's clothing. Further, older technologies such as electron-beams and X-rays have been adapted so that they can penetrate an equivalent of 14 to 16 inches of steel to scan up to one hundred, forty-foot sea-land shipping containers a day to detect contraband ranging from explosives to guns to drugs.

Although significant advances have been made with respect to generating images using such technologies, relatively few advances have been made with respect to automatically interpreting the content of generated images. Efforts to automatically detect and recognize objects of interest, or target objects, within a generated image typically encounter a wide variety of obstacles that have proven difficult to overcome using conventional image processing techniques. For example, objects of interest, or target objects, may vary significantly in physical shape, composition and other physical characteristics. Further, the appearance of an object within an image may vary depending upon the aspect ratio angle, or orientation, of the object relative to the point from which the image is generated. In addition, a view of an object within an image may be partially blocked and/or cluttered due to background noise and/or objects in proximity to the object of interest. For example, views of a contraband object may be purposefully blocked/cluttered with additional objects in an effort to avoid detection. Further, the contraband object may be oriented within a closed package in a manner that results in a non-conventional view of the object.

Conventional approaches typically use template matching to recognize an object, such as a weapon. Unfortunately, such template matching is sensitive to changes in object rotation and changes in object scale. Further, template matching is a computationally complex process and has difficulty detecting objects within cluttered and/or partially obstructed views.

Given the current state of conventional object detection/recognition techniques, attempts to automate object detection and to automate recognition of detected objects often result in a high number of undetected/unrecognized target objects and a high number of false target object recognitions. As a result of such poor performance, generated images are typically interpreted by technicians who have been specifically trained to interpret one or more types of generated images and to detect/recognize objects within a generated image. For example, interpretation of a medical image typically requires careful visual inspection by a trained medical specialist to locate, identify, and assess objects located within the image. Further, military imagery analysts, earth scientists, archeologists and oceanographers are typically required to visually analyze generated images in order to detect and recognize objects of interest, or target objects, within the image. With respect to the detection and recognition of contraband objects, U.S. Customs officers and U.S. Transportation Security Administration security personnel are needed to review generated images in order to identify objects of interest, or target objects, within images of X-rayed luggage/cargo and/or images of passengers produced using infrared and/or millimeterwave imaging devices.

The need for trained and/or experienced personnel to effectively operate conventional object detection and recognition systems greatly increases the operational costs of organizations that use such conventional systems. Further, approaches that rely upon visual analysis by human operators remain susceptible to human error as a result of operator fatigue and/or lapses in concentration. For example, in high volume environments such as personnel, luggage and cargo inspections at busy airports, seaports and railway stations, attempts to rapidly assess image content based upon operator analysis of generated image have proven to be highly susceptible to human error.

Hence, a need remains for a highly accurate, automated approach for detecting and recognizing objects of interest, or target objects, within a generated image. Preferably, such an approach would be compatible with a wide variety of generated image types and could be trained to detect a wide variety of objects within the generated images, thereby making the object detection and recognition system capable of supporting a large number of diverse operational missions. Preferably such a method and apparatus would support fully automated detection of objects of interest within a generated image and/or would assist human operators by automatically identifying objects of interest within a generated image. Further, such a method and apparatus would preferably be capable of assessing generated images for objects of interest in real-time, or near real-time.

### OBJECTS AND SUMMARY OF THE INVENTION

Therefore, in light of the above, and for other reasons that may become apparent when the invention is fully described, an object of the present invention is to automate detection and recognition of objects within images generated by a wide range of imaging technologies in support of a wide range of image processing applications.

Another object of the present invention is to facilitate operator interpretation of noisy, partially obstructed images while preserving operator confidence in enhanced/processed images.

Yet another object of the present invention is to reduce the level of operator training/experience needed to accurately recognize objects detected within an image.

Still another object of the present invention is to reduce human error in the recognition of objects detected within an image.

A further object of the present invention is to increase the accuracy of image based object detection/recognition systems.

A still further object of the present invention is to increase the throughput of image based object detection/recognition systems.

The aforesaid objects are achieved individually and in combination, and it is not intended that the present invention be construed as requiring two or more of the objects to be combined unless expressly required by the claims attached hereto.

A method and apparatus is described for recognizing objects detected within a generated image. Recognition of an object detected within an image is based upon a comparison of descriptor values determined for the detected object with descriptor value ranges stored in an information base for descriptors associated with one or more target objects. The information base may include a set of object descriptor ranges for each object of interest, or target object, that the object recognition system is trained to detect. A set of stored target object descriptor ranges may be further organized into subsets in which each subset includes a plurality of object descriptors ranges determined for a view of a target object from a unique angular view.

The apparatus of the present invention may be trained to detect any two-dimensional or three-dimensional object by determining a range of values for descriptors associated with each object of interest, or target object, for each of a plurality of views of the target object. Preferably, object descriptors used to describe a view of an object are invariant to the object's translation (i.e., position), scale, and rotation (i.e., orientation). For example, a set of invariant shape descriptors may include: a measure of how circular, or round, a view of an object is; a parameter (e.g., magnitude) based upon a Fourier description of a view of the object; and/or a parameter based upon an analysis of central moments of order of a view of the object.

To reflect the relative significance of individual object descriptors, each object descriptor may be associated with a heuristically determined weighting value. A weight associated with an object descriptor may be determined during a training process in which a selected set of descriptors are used to identify views of a target object within a plurality of test images. During the training process, descriptors may be added or removed and weight values assigned to descriptor values associated with a target object may be adjusted. Typically, the training process proceeds until a set of descriptors and weights are defined that achieved an acceptable high probability of detection and an acceptably low probability of false detection.

In one embodiment of the present invention, a generated image is automatically adjusted to remove surface distortions (i.e., distortions in image brightness, contrast, etc.) unrelated to the image's subject matter. In such an embodiment, an operator is preferably provided with access to a visual presentation of the original un-processed version of the image as well as access to enhanced/processed versions of the image.

In another embodiment, the ability to detect objects within an image is enhanced by creating multiple component images from a single generated image based upon a plurality of user selected and/or automatically generated pixel intensity threshold values. Objects are detected within each component image using conventional image processing techniques and the objects detected within the individual component images are then correlated and combined to create composite images of detected objects.

The apparatus and method of the present invention may be applied to the detection of objects within images generated by any imaging technology in support of a wide range of image processing applications. Such application may include, but are not limited to, site security surveillance, medical analysis diagnosis, interpretation of geographic/military reconnaissance imagery, visual analysis of laboratory experiments, and the detection of concealed contraband upon individuals and/or within sealed containers. For example, in one embodiment of the present invention, the object recognition system is trained to detect concealed explosive devices by recognizing the explosive filler associated with a plurality of conventional explosive detonators within X-ray generated images.

The methods and apparatus described here provide a highly accurate, automated approach for detecting and recognizing objects of interest, or target objects, within a generated image. The approach described is compatible with a wide variety of generated image types and can be trained to detect a wide variety of objects within the generated images, thereby making the object detection and recognition system capable of supporting a large number of diverse operational missions. The described methods and apparatus support fully automated detection of target objects within a generated image and/or can assist human operators by automatically identifying objects of interest within a generated image. The method and apparatus is capable of assessing generated images for objects of interest in real-time, or near real-time.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a block diagram of an object recognition system in accordance with an exemplary embodiment of the present invention.

FIG. 2 is a process flow diagram for building an information base containing object descriptors in accordance with an exemplary embodiment of the present invention.

FIG. 3 is a process flow diagram for recognizing objects detected within an image in accordance with an exemplary embodiment of the present invention.

FIG. 4A is a graphical representation of angles that may be used to describe free rotation of an object.

FIG. 4B is a graphical representation of the volume of three-dimensional space volume through which an object may be rotated.

FIG. 5 is a process flow diagram for enhancing/desurfacing an unprocessed image in accordance with an exemplary embodiment of the present invention.

FIG. 6 is a process flow diagram for detecting objects within an image in accordance with an exemplary embodiment of the present invention.

FIG. 7A charts a probability of detection as a function of an operator configured threshold probability of detection (P_{D}) value in accordance with an exemplary embodiment of the present invention.

FIG. 7B charts a probability of false alarms as a function of an operator configured threshold probability of detection (P_{D}) value in accordance with an exemplary embodiment of the present invention.

FIG. 8 is a user interface used to provide an operator with convenient access to views of original images, processed/enhanced images and images identifying detected and/or recognized objects in accordance with an exemplary embodiment of the present invention.

### DETAILED DESCRIPTION OF THE PREFERRED EMBODIMENTS

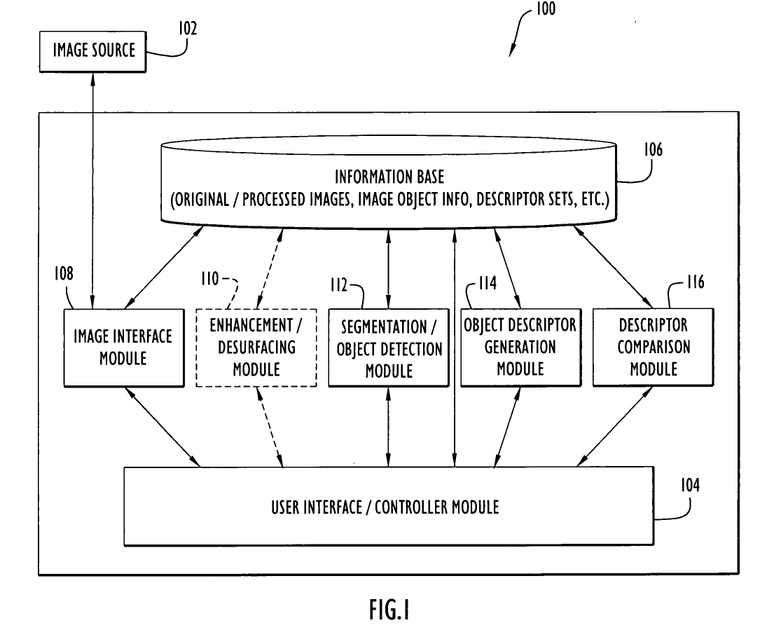

FIG. 1 presents a block diagram of an object recognition system in accordance with an exemplary embodiment of the present invention. As shown in FIG. 1, object recognition system 100 may include a user interface/controller module 104 in communication with an information base 106. Object recognition system 100 may further include an image interface module 108, an optional enhancement/de-surfacing module 110, a segmentation/object detection module 112, an object descriptor generation module 114, and a descriptor comparison module 116. Each of these modules may communicate with information base 106, either directly or via user interface/controller module 104.

Object recognition system 100 may receive an image from an external image source 102 via image interface module 108 in accordance with operator instructions received via user interface/controller module 104 and may store the received image in information base 106. Once an image has been received/stored, object recognition system 100 may proceed to process the image in accordance with stored and/or operator instructions initiated by user interface/controller module 104. Information base 106 may serve as a common storage facility for object recognition system 100. Modules may retrieve input from information base 106 and store output to information base 106 in performance of their respective functions.

Prior to operational use, object recognition system 100 may be trained to recognize a predetermined set of objects of interest, or target objects. This is accomplished by populating information base 106 with target object descriptor sets. A target object descriptor set contains value ranges for each descriptor selected for use in recognizing a target object. A target object descriptor set may be divided into subsets, each subset containing a value range for each selected target object descriptor based upon an image of the target object viewed from a specific aspect view angle (i.e., the stored value/value range in each target object descriptor subset may be aspect view angle dependent).

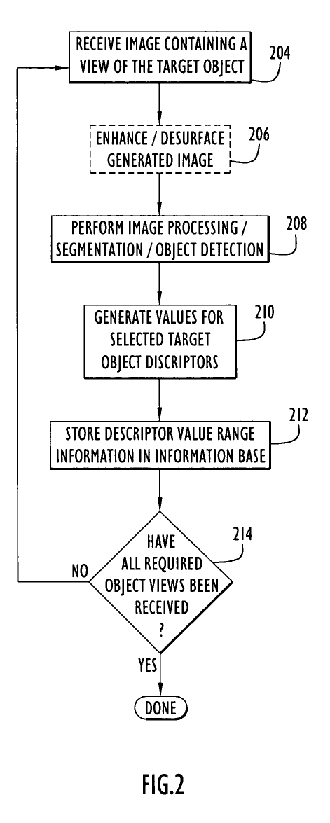

FIG. 2 is a process flow diagram for populating an object recognition system with target object descriptors in accordance with an exemplary embodiment of the present invention. As shown in FIG. 2, object recognition system receives, at step 204, an image containing a view of a target object from a specific angle. The image is optionally enhanced/desurfaced, at step 206, by enhancement/desurfacing module 110 to remove contributions to the image from sources unrelated to objects detected within the image as described in greater detail below. Next, the image is processed, at step 208, using image processing techniques to identify the target object within the image and values are generated, at step 210, for each selected target object descriptor based upon the view of the target object. The determined descriptor values are used to generate a value range for each target object descriptor, at step 212. The target object descriptor value range is stored within a view specific subset of the set of target object descriptors associated with a defined target object and stored within the object recognition system information base. Upon determining, at step 214, that additional views of the target object remain to be processed, the process workflow returns to step 204 to receive an image of the target object captured from another predetermined angle, otherwise, the process is complete.

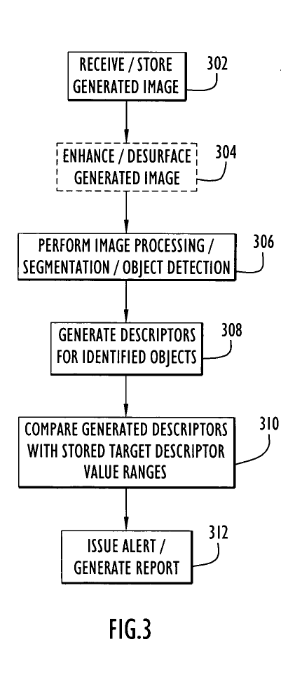

FIG. 3 presents a process flow diagram for recognizing objects within a received image in accordance with an exemplary embodiment of the present invention. As shown in FIG. 3, an image is received, at step 302, by image interface module 108 (FIG. 1) and stored in information base 106. The stored original image may be optionally retrieved and processed, at step 304, by enhancement/desurfacing module 110 to remove contributions to the image from sources unrelated to objects detected within the image, as described in greater detail below. Upon completion of processing by enhancement/desurfacing module 110, the enhanced/desurfaced image may be stored in information base 106.

The optionally enhance/desurfaced image is processed by segmentation/object detection module 112 using image processing techniques to detect, at step 306, objects within the image. Information related to objects detected within the image may be stored in information base 106 in association with the image. Next, values are generated, at step 308, for a predetermined set of target object descriptors for each object detected within the image. The generated descriptor object values are compared, at step 310, with sets of target object descriptor value ranges stored in information base 106, described above with respect to FIG. 2, in order to locate a match. If a generated object descriptor value is within a stored target object descriptor value range, a descriptor match is considered positive. If a generated object descriptor value is not within a stored target object descriptor value range, a match is considered negative. Based upon an assessment of the positive descriptor matches, the user interface/controller module 104 determines, as described in greater detail below with respect to EQ. 1, whether the detected object is likely a target object defined within information base 106.

Upon determining that a detected object is likely one of a plurality of target objects for which the object recognition system has been trained to recognize, an alert may be issued to an operator via the user interface. Such an alert may include one or more of an audible alarm and a graphical and/or text base alert message displayed via the object recognition system user interface/controller module 104. Further, upon issuing an alert, the object recognition system platform may be pre-configure to perform any of a plurality of subsequent actions, depending upon the nature of the target object and the operational environment in which the target object is recognized. In addition, a report that summarizes the results of the comparison process may be generated, at step 312, and presented to the operator via user interface/controller module 104.

In one non-limiting, representative embodiment, object recognition system 100 is implemented as software executed upon a commercially available computer platform (e.g., personal computer, workstation, laptop computer, etc.). Such a computer platform may include a conventional computer processing unit with conventional user input/output devices such as a display, keyboard and mouse. The computer processing unit may use any of the major operating systems such as Microsoft Windows, Linux, Macintosh, Unix or OS2, or any other operating system. Further, the computer processing unit includes components (e.g. processor, disk storage or hard drive, etc.) having sufficient processing and storage capabilities to effectively execute object recognition system processes. The object recognition system platform may be connected to a source of images (e.g., stored digital image library, X-ray image generator, millimeterwave image generator, infrared image generator, etc.). Images may be received and/or retrieved by object recognition system 100 and processed, as described above, to detect objects within images and to recognize target objects among the detected objects.

The present invention recognizes a target object from among a plurality of objects detected within an image based upon a set of target object descriptor value ranges stored for each target object in an information base. In a preferred embodiment, the object descriptors used to describe a view of an object are invariant to the object's translation (i.e., position), scale, and rotation (i.e., orientation). For example, a set of invariant shape descriptors may include: a measure of how circular, or round, a view of an object is; a parameter (e.g., magnitude) based upon a Fourier description of a view of the object; and/or a parameter based upon an analysis of central moments of order of a view of the object. Recognition of an object within an image may be based upon a comparison of object descriptor values determined for an object detected within an image with target object descriptor value ranges stored in the information base.

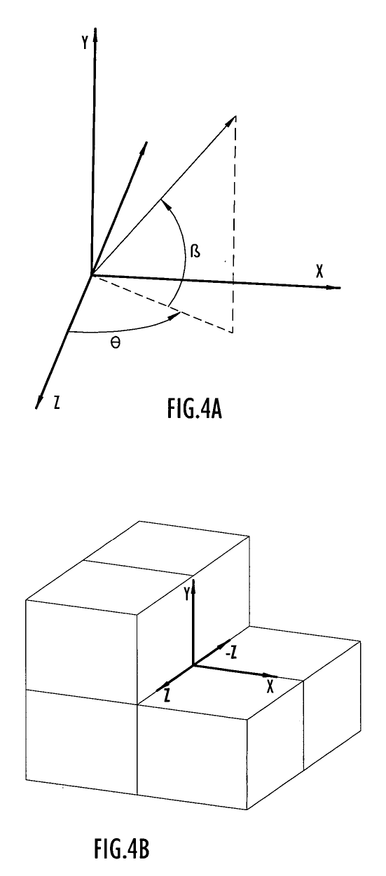

FIG. 4A is a graphical representation of angles θ and β that may be used to describe free rotation of an object in a three-dimensional coordinate space (X, Y, Z). For example, an object centered at the origin (0, 0, 0) of three-dimensional coordinate space (X, Y, Z) may be rotated in 360° in the direction of each of angles θ and β to achieve any of an infinite number of aspect view angles relative to a stationary two-dimensional projection plane to create a virtually infinite number of potentially unique projected images of the object.

However, if a projected image of an object is described using rotation invariant shape descriptors (i.e., object shape descriptors that are unaffected by changes in rotation) the number of degrees through which an object must be rotated to generate a complete set of unique projected images is greatly reduced. In fact, if rotation invariant shape descriptor are used, a complete set of unique projected images for a randomly shaped three-dimensional object may be generated by rotating the object between 0° to 180° in the direction of angle θ and rotating the object between 0° to 90° in the direction of angle P. As shown graphically in FIG. 4B, rotating an object between 0° to 180° with respect to angle θ and between 0° to 90° with respect to angle β includes only one-quarter of the three-dimensional volume through which an object would have to be rotated to generate a set of shape descriptors capable of describing all possible projected images, if rotation invariant shape descriptors are not used. Further, using the techniques described below, angle θ need only be varied from 0° to 180° in increments (e.g., 20 degree increments) and angle β may be varied from 0° to 90° in increments (e.g., 20 degree increments) to support generation of a complete set of target object descriptor value ranges, assuming rotation invariant shape descriptors are used. Such a set of rotation invariant target object descriptors can be used to recognize a randomly shaped two or three-dimensional target object based upon a projected image of the target object from any angle. However, the object recognition system of the present invention is not limited to the use of invariant target object descriptors. Optional embodiments may include sets of target object descriptors that include any combination of invariant and variant target object descriptors or sets of descriptors that include only variant object descriptors.

Although virtually any imaging technology may be used to generate images processed by the object recognition system of the present invention, the types of descriptors used and the number of descriptors required may vary depending upon the imaging technology selected. For example, any two-dimensional image of a three-dimensional object can be characterized with a set of descriptors (e.g., size, shape, color, texture, reflectivity, etc). However, depending upon the imaging technology used and the nature of the object to be detected, the type and number of descriptors, and the complexity of the processing required to accurately detect an object within an image may vary significantly.

For example, imaging technologies (such as X-ray, millimeterwave technologies, infrared thermal imaging, etc.), used to detect concealed weapons, explosives and other contraband contained within closed containers and/or concealed beneath the clothing of an individual under observation, typically generate a two-dimensional projection, or projected image, of a detected three-dimensional object. Such two-dimensional projections vary in shape based upon an aspect view angle of the three-dimensional object with respect to a two-dimensional projection plane upon which the projected image is cast.

If an imaging technology is used that creates such two-dimensional projected images, an object recognition system information base may be populated with a set of scale and rotation invariant shape descriptors for each target object to be detected by the system. In one embodiment, a set of invariant shape descriptor value ranges may be determined for views based upon 20° shifts in angles β and θ for angular ranges described above with respect to FIG. 4A and FIG. 4B, for each intended target object. In building a target object descriptor set, a standard deviation and median value may be stored for each descriptor/angular view of a target object. Descriptors for a specific angular view may be stored as a target object descriptor set subset, as described above (i.e., the stored value/value range in each target object descriptor subset may be aspect view angle dependent).

Use of an imaging system that produces projection images of detected object and use of rotation and scale invariant descriptors may significantly reduce the number of angles for which target object descriptor value ranges must be generated and stored in order for the object recognition system of the present invention to successfully recognize a select number of target objects. For example, as described with respect to FIGS. 4A and 4B, in a object recognition system tailored to recognize objects based upon images produced with a projection based imaging system, such as an X-ray imaging system, rotation invariant shape descriptors angle θ within the X/Z plane need only vary from 0° to 180° and angle β needs to vary from 0° to 90° both at 20° shifts to generate a set of target object descriptors that fully describe a randomly shaped three-dimensional object.

In one representative embodiment, several images are generated for each angle view of an object and the values determined for each of the respective descriptors are assessed to provide a mean and a standard deviation for the descriptor. These values are stored within the object recognition information base and serve as a basis for generating target object descriptor value ranges used for identifying objects as described above with respect to FIG. 3, step 310.

In an exemplary embodiment of the present invention, the target object descriptors selected may be a set if invariant shape descriptors (i.e., invariant to the object's translation scale, and/or rotation) and a set of target object descriptor value ranges are generated for each invariant shape descriptor based upon different rotational views of a target object. A median MDₗ and standard deviation STDᵢ values are determined for each shape descriptor Dₗ at each rotation Rⱼ and a weighting value Wₗ is assigned to each descriptor Dᵢ.

For each descriptor Dᵢ and each rotation Rⱼ a set of limits [Lᵢⱼ, Hᵢⱼ] may be defined such that Lᵢⱼ=MDᵢ(Rⱼ)−A.STDᵢ(Rⱼ) and Hᵢⱼ=MDᵢ(Rⱼ)+A.STDᵢ(Rⱼ), where A is a parameter that is defined heuristically as part of the object recognition training process used to validate the effectiveness of a stored set of object descriptors. Weighting values may also be defined heuristically as part of the object recognition training process.

By determining a range of acceptable object descriptor values based upon upper and lower values determined using equations for Lᵢⱼ and Hᵢⱼ, described above, introduces flexibility into the object descriptor based object recognition process of the present invention. Use of multiple object descriptors, each with a heuristically developed values for A and Wᵢ, allows the object recognition system of the present invention to be highly configurable for use in supporting a wide range of operational missions based upon input from a wide range of imaging systems.

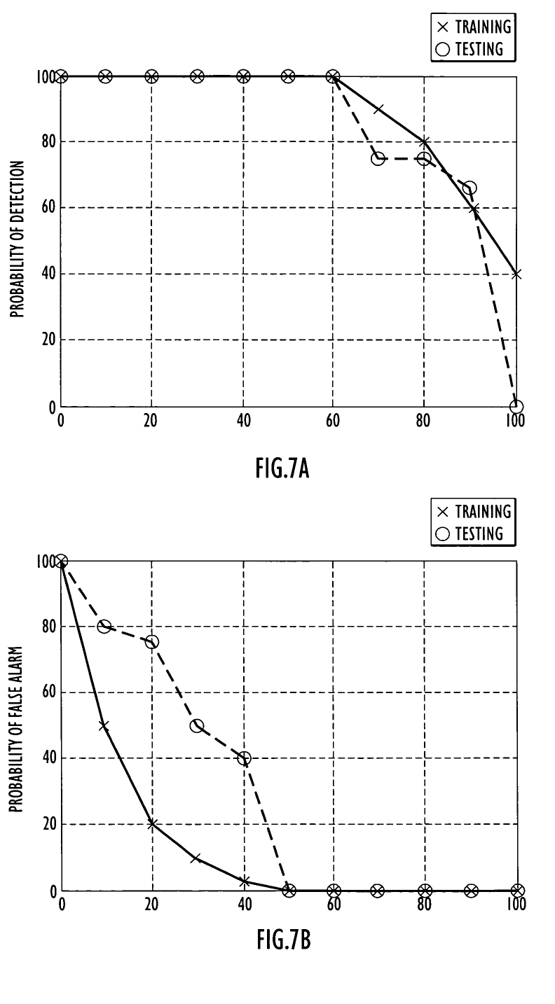

The number and type of object descriptors, values for A and Wᵢ, and the incremental shifts in angle θ and angle β used to generate views used to generate an object descriptor set, may be heuristically fine tuned as part of the object recognition system training process until acceptable probabilities of detection and acceptable probabilities of false alarms are achieved, as addressed below with respect to FIG. 7A and FIG. 7B. Use of such a flexible, heuristically trained approach, allows sets of target object descriptor value ranges stored within the object recognition information store to be based upon views of the target object taken at discrete angular increments (e.g., 20 degree increments), as described above, thereby greatly reducing the number of unique views for which target object descriptor value ranges must be determined. If only rotationally invariant object descriptors are used, the range of angles over which sets of object descriptors must be generated is reduced, as described with respect to FIG. 4A and FIG. 4B. Selecting rotationally variant descriptors, or a combination of rotationally variant and invariant descriptors, increases the range of angles over which sets of target object descriptor value ranges must be generated to assure that the target object can be recognized.

Values for Lᵢⱼ, Hᵢⱼ and an optional weighting value Wᵢ may be stored within the object recognition system 100 (FIG. 1) information base 106 in association with a target object and the relative object rotation for which each was determined, as shown below in Table 1.

TABLE 1
Exemplary Object Descriptors

| | R₁ | R₂ | Etc. |
|---|---|---|---|
| D₁ | L₁₁, H₁₁, W₁ | L₁₂, H₁₂, W₁ | |
| D₂ | L₂₁, H₂₁, W₂ | L₂₂, H₂₂, W₂ | |
| Etc. | | | |

Alternatively, values for MDᵢⱼ, STDᵢⱼ and an optional weighting value Wᵢ may be stored within the object recognition system 100 (FIG. 1) information base 106 in association with an object and the relative object rotation for which each was determined, as shown below in Table 2.

TABLE 2
Exemplary Object Descriptors

| | R₁ | R₂ | Etc. |
|---|---|---|---|
| D₁ | MD₁₁, STD₁₁, W₁ | MD₁₂, STD₁₂, W₁ | |
| D₂ | MD₂₁, STD₂₁, W₂ | MD₂₂, STD₂₂, W₂ | |
| Etc. | | | |

Once the object recognition system information base has been populated with a set of descriptor range values for one or more target objects, as described above, the system may be used to detect the respective target object based upon the sets of stored descriptor range values. For example, as described above with respect to FIG. 3, once an image has been segmented and objects have been detected within the image, at step 306, a set of descriptor values Dᵢ(Test_Object) is generated, at step 308, for each detected object. The set of descriptors is compared, at step 310, for all rotations Rⱼ to determine whether Lᵢⱼ<=Dᵢ(Test_Object)<=Hᵢⱼ. The result of this comparison may be represented as a table, as shown below in Table 3, in which Vᵢⱼ=1 if the condition above is true and Vᵢⱼ=0 if the condition above is false.

TABLE 3
Exemplary Descriptor Comparison Results Table

| | R₁ | R₂ | Etc. |
|---|---|---|---|
| D₁ | Vᵢⱼ | Vᵢⱼ | |
| D₂ | Vᵢⱼ | Vᵢⱼ | |
| Etc. | | | |

For each test object form a normalized parameter Pⱼ(Test_Object) is determined based upon EQ₁, below, such that,

$${P}_{j} ( Test\_Object ) = \frac{{\sum }_{i} {V}_{ij} * {W}_{i}}{{\sum }_{i} {W}_{i}} \qquad EQ . 1$$

Note that Pⱼ(test_object) is normalized to be between the values of 0 and 1 to represent a probability of detection in terms of percentage. In this manner, a super-descriptor is computed based upon the individual descriptor evaluations (i.e., “0” or “1”) by weighting them, and combining them into a single scalar. The super-descriptor of each test object is compared to a preset threshold. The test object is labeled target and highlighted if the super-descriptor is higher than a probability of detection threshold (P_{D}).

An example of super-descriptors determined for a set of identified objects for each of a range of angled views is shown below in Table 4. Note that in this case and for rotations in the horizontal plan, it is found that objects number 6 and 7 are objects with 90° rotation and have Pⱼ(TEST_OBJECT)>=60%.

TABLE 4
Super Descriptor Values in %

| Test | | | | | | | | | | | |
|---|---|---|---|---|---|---|---|---|---|---|---|
| Objects | 0 | 20° | 40° | 60° | 80° | 90° | 100° | 120° | 140° | 160° | 180° |
| 1 | 0 | 0 | 0 | 0 | 0 | 0 | 0 | 0 | 0 | 0 | 0 |
| 2 | 0 | 0 | 0 | 0 | 0 | 0 | 0 | 0 | 0 | 0 | 0 |
| 3 | 0 | 0 | 0 | 0 | 0 | 45 | 0 | 0 | 0 | 0 | 0 |
| 4 | 0 | 0 | 0 | 0 | 0 | 52.5 | 0 | 0 | 0 | 0 | 0 |
| 5 | 0 | 0 | 0 | 0 | 0 | 35 | 0 | 0 | 0 | 0 | 0 |
| 6 | 0 | 0 | 0 | 0 | 0 | 70 | 0 | 0 | 0 | 0 | 0 |
| 7 | 0 | 0 | 0 | 0 | 0 | 70 | 0 | 0 | 0 | 0 | 0 |
| 8 | 0 | 0 | 0 | 0 | 0 | 0 | 0 | 0 | 0 | 0 | 0 |
| 9 | 0 | 0 | 0 | 0 | 0 | 0 | 0 | 0 | 0 | 0 | 0 |
| 10 | 0 | 0 | 0 | 0 | 0 | 40 | 0 | 0 | 0 | 0 | 0 |
| 11 | 0 | 0 | 0 | 0 | 0 | 37.5 | 0 | 0 | 0 | 0 | 0 |
| 12 | 0 | 0 | 0 | 0 | 0 | 0 | 0 | 0 | 0 | 0 | 0 |
| 13 | 0 | 0 | 0 | 0 | 0 | 0 | 0 | 0 | 0 | 0 | 0 |
| 14 | 0 | 0 | 0 | 0 | 45 | 50 | 45 | 0 | 0 | 0 | 0 |
| 15 | 0 | 0 | 0 | 0 | 0 | 40 | 0 | 0 | 0 | 0 | 0 |
| 16 | 0 | 0 | 0 | 0 | 37.5 | 40 | 40 | 0 | 0 | 0 | 0 |
| 17 | 0 | 0 | 0 | 0 | 35 | 42.5 | 40 | 0 | 0 | 0 | 0 |
| 18 | 0 | 0 | 0 | 0 | 0 | 47.5 | 0 | 0 | 0 | 0 | 0 |
| 19 | 0 | 0 | 0 | 0 | 0 | 45 | 0 | 0 | 0 | 0 | 0 |
| 20 | 0 | 0 | 0 | 0 | 0 | 42.5 | 0 | 0 | 0 | 0 | 0 |
| 21 | 0 | 0 | 0 | 0 | 0 | 40 | 0 | 0 | 0 | 0 | 0 |
| 22 | 0 | 0 | 0 | 0 | 0 | 45 | 0 | 0 | 0 | 0 | 0 |

As described above, the set of descriptors and weights used by the object recognition system to detect one object may vary significantly from the set of descriptors and weights used by the object recognition system to detect another object. Further, the set of descriptor value ranges and weights used for an individual object may change depending upon the type of imaging system used to generate the image within which a target object is to be recognized. In refining a set of descriptors for a target object, a training period may be used to verify the effectiveness of different combinations of descriptors and to assign weights to the respective descriptors.

The object recognition system of the present invention may be configured to identify a detected object as a target object if the determined super-descriptor probability for a detected object Pⱼ(TEST_OBJECT) is greater than P_{D}. The threshold probability of detection (P_{D}), as described above, may be an operator configurable threshold value. As P_{D} is lowered, the number of recognized object will increase, but so may the number of false detections. For example, if P_{D} is set to 0%, all targets detected within an image during the segmentation/object detection process will be identified as recognized objects. By training the object recognition system via the selection of a set of weighted descriptors, as described above, a P_{D} value may be determined which provides close to 100% probability of detection and close to 0% probability of false alarm. An operator may optionally configure the value of P_{D} in order to reach a balance of detections and false alarms appropriate for the operational environment.

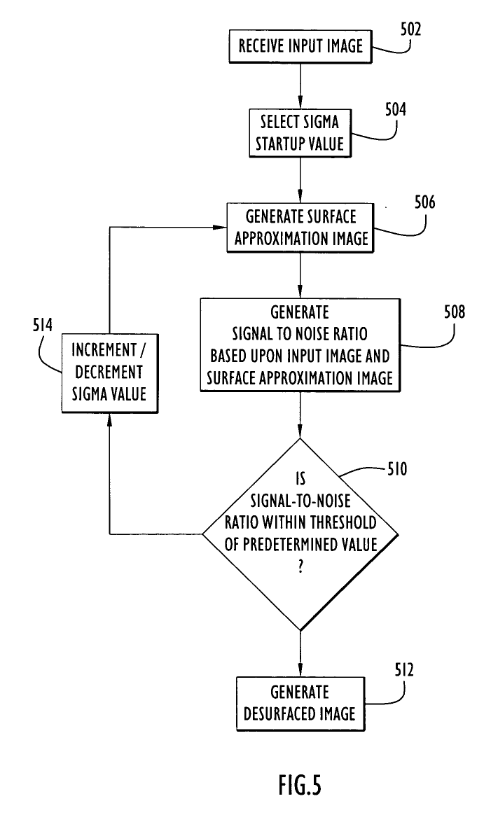

FIG. 5 is a process flow diagram for enhancing/desurfacing an unprocessed image as described with respect to FIG. 2, at step 206, and with respect to FIG. 3, at step 304. Some imaging systems (such as X-ray imaging systems capable of generating images of objects within an enclosed case) emit energy that is more concentrated in the center of the transmitter and dissipates in relation to the distance from the center of the transmitter. Such uneven emission of energy is typically represented within the images generated by such a system. For example, digital data collected by such an imaging system may show a bright contrast in the center of a generated image that dissipates along a path from the center of the image to an outer edge of the drawing. If such an imaging system is used, the present invention allows for the optional correction of such contributions to images introduced by such systems.

As shown in FIG. 5, upon receipt, at step 502, of an image containing a background component attributable to the imaging system that produced the image, an initial standard deviation, or sigma value, is selected, at step 504, and used to generate, at step 506, an approximation of the background component based upon a model that is capable of approximating the intensity of the background component. For example, the background contribution of an X-ray imaging system may be modeled using a model based upon a quasi-Gaussian distribution, but models based upon other distributions may be used depending upon the nature of the background contribution.

Once an approximation of the image surface, or background component, is generated, at step 506, a signal to noise ratio is determined, at step 508, based upon the image received, at step 502, and the surface approximation generated at step 506. For example, a signal to noise ratio (SNR) may be determined using the EQ. 1, below, in which Input is the image received at step 502 and Output is the surface approximation generated at step 506. If the signal-to-noise ratio is determined, at step 510, to be within a predetermined margin of error (e.g. ±3 dB) of a predetermined signal-to-noise target value, the received image is desurfaced, at step 512, by subtracting the approximated surface image from the image received at step 502. With respect to step 510, a predetermined signal-to-noise target value of 35 dB has been heuristically shown to produce good results. If the signal-to-noise ratio determined, at step 510, exceeds the predetermined margin of error, the value of sigma is adjusted, at step 514, to reduce the margin of error and processing continues, as described above, with the generation of a new surface approximation, at step 506, until the target signal-to-noise ratio is achieved.

For example, recursive filters using a quasi-Gaussian kernel and a startup value for the standard deviation (spread), or sigma, may be used to generate an approximation of an image surface based upon EQ. 2, below.
SNR=10*log 10(sum(sum((Input−Output)/Output))) EQ. 2
SNR values may be determined and the value of sigma may be adjusted until the determined SNR value approaches a heuristically determined target value (e.g., 35 dB, as described above). Once an SNR of approximately 35 dB is achieved, a desurfaced image is generated by subtracting the approximated surface (i.e., the output) from the received input image, as shown in EQ. 3 below.
Desurfaced=Input−Output EQ. 3

Desurfacing an image, as described above, eliminates contributions to the surface of the image that are unrelated to objects represented within the image. Elimination of such extraneous contributions facilitates the detection of objects within the processed image. As described above, such processing may be performed, optionally, based upon the nature of the imaging system used. If an imaging system is used that does not introduce unrelated image surface characteristics, the image desurfacing process, described above, is not required.

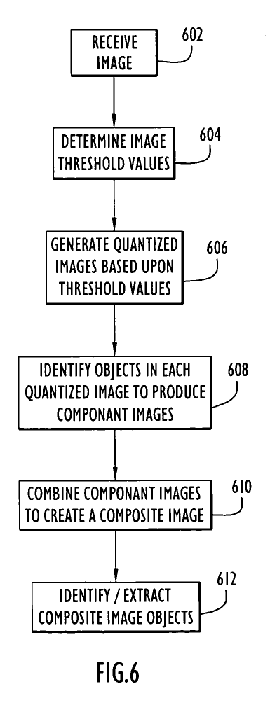

FIG. 6 is a process flow diagram for detecting objects within an image as described with respect to FIG. 2, at step 208, and with respect to FIG. 3, at step 306. As shown in FIG. 6, upon receiving an original or enhanced/desurfaced image, at step 602, significant threshold values within the image data are identified, at step 604, for regions with distinguishable intensity levels and for regions with close intensity levels. Regions with distinguishable intensity levels have multi-modal histograms, whereas regions with close intensity levels have overlapping histograms. Thresholds are computed for both cases and fused to form a set of important thresholds that preserve all information contained in the scene. Next, at step 606, the image is quantized for each identified threshold value, thereby creating a binary image for each identified threshold. Next, adaptive filtering, pixel grouping and other conventional image processing techniques are used to identify, at step 608, objects within each quantized image, thereby creating a component image containing objects detected at the specified threshold level. The component images corresponding to respective identified threshold values may then be combined, at step 610, to create a composite image that shows objects present at different intensity levels with different colors and/or gray levels. Next, conventional image processing techniques may be used upon the composite image to identify, at step 612, composite objects within the composite image.

As described above with respect to FIG. 4A and FIG. 4B, a set of invariant shape descriptors may be used to describe a view of an object captured in an image. In accordance with the present invention, a shape descriptor is preferably invariant to an object's translation (position), scale, and rotation (orientation). Thus, a set of invariant shape descriptors that may be used to describe views of an object may include shape descriptors based upon circularity, Fourier Descriptors, and moments, as described below.

The circularity of an object is a measure of how circular or elongated an object appears. Given an object with area A and perimeter P, circularity C may be defined as shown in EQ. 4, below.
C=P²/A EQ. 4
Thus, C measures how circular or elongated the object is. Typically, the area A is equal to the number of pixels contained within a detected object's boundaries, whereas the perimeter P is computed from the pixels located on the boundary of the object.

Fourier descriptors are typically based upon Fourier series representation of a physical characteristics of an object. For example, let the boundary of a particular object have N pixels numbered 0 to N−1. The K^{th} pixel along the contour has position (xₖ,yₖ). A complex coordinate sₖ=xₖ+j.yₖ is formed from the Cartesian coordinates. Note that sₖ is a cyclic curve (i.e., periodic) and as such it can be expanded in a Fourier series with coefficients, as shown in EQ. 5, below.

$${\hat{s}}_{u} = \frac{1}{N} {\sum }_{k = 0}^{N - 1} {s}_{k} exp ( \frac{- 2 π uk}{N} ) \qquad EQ . 5$$

Translation invariance is achieved by leaving out ŝ₀, scale invariance is obtained by setting the magnitude of the second Fourier descriptor ŝ₁ to one, and rotation invariance is attained by relating all phases to the phase of ŝ₁. Different parameters based on the Fourier descriptors may be used as representative of an object's shape. For example, a shape descriptor may be based upon a magnitude of a Fourier descriptor, as shown in EQ. 6, below.

$${F}_{1} = {\sum }_{u = - N / 2}^{N / 2} abs ( {\hat{s}}_{u} ) \\ {F}_{2} = [ \begin{matrix}{\sum }_{u = 2}^{N / 2} abs ( {\hat{s}}_{u} + {\hat{s}}_{( N - u + 2 )} ) & if rem ( N , 2 ) = 0 \\ {\sum }_{u = 2}^{( N - 1 ) / 2} abs ( {\hat{s}}_{u} + {\hat{s}}_{( N - u + 2 )} ) & if rem ( N , 2 ) = 1\end{matrix} \qquad EQ . 6$$

A shape descriptors may also be based upon a moment determined for an object. For example, given an object in a Cartesian plan (x,y) and the object's gray value function g(x,y), the central moments of order (p,q) are given by EQ. 7, below.
m_{p,q}=∫∫(x−\overline{x})^{p}(y−\overline{y})^{q}g(x,y)dxdy EQ. 7
Computation of the central moments for discrete binary images reduces EQ. 7 to EQ. 8, below.
m_{p,q}=Σ(x−\overline{x})^{p}(y−\overline{y})^{q} EQ. 8
Scale invariance is achieved by normalizing the central moments with the zero order moment, as shown in EQ. 9, below.

$${η}_{p , q} = \frac{{m}_{p , q}}{{m}_{0 , 0}^{( p + q + 2 ) / 2}} \qquad EQ . 9$$

Shape parameters based on the second and third order normalized moments that are translation, 5 scale, and rotation invariant, as shown in EQ. 10, below.
φ₁=η₂₀+η₀₂
φ₂=(η₂₀−η₀₂)²+4η₁₁²
φ₃=(η₃₀3η₁₂)²+(3η₂₁−η₀₃)²
φ₄=(η₃₀+η₂₁+η₀₃)²
φ₅=(η₃₀−3η₁₂)[(η₃₀+η₁₂)(²−3(η₂₁+η₀₃)²]+(3η₂₁−η₀₃)(η₂₁+η₀₃)[3(η₃₀+η₁₂)²−(η₂₁+η₀₃)²]
φ₆=(η₂₀−η₀₁)[(η₃₀+η₁₂)²−(η₂₁+η₀₃)²]+4η₁₁(η₃₀+η₁₂)(η₂₁+η₀₃) EQ. 10
For example, equations 1, 3, and 4 represent the 9 shape parameters may be used to automatically detect target objects in images generated by any image generator. It should be noted that shape descriptors based upon moments are equal to zero for symmetric objects yet return a value for a non-symmetric object. Therefore, if a target object is symmetric, a weight assigned to a moment based shape is typically smaller, whereas, if the target object is non-symmetric, a weight assigned to a moment based shape is typically larger.

Such a base of scale and rotation invariant shape descriptors may be used to detect an object of interest within any two-dimensional projected image that includes a two-dimensional projected view of a target object, regardless of the aspect view angle of the target object within the image. Using this approach, the present invention overcomes the disadvantages of conventional approaches such as template matching, identified above. Further, the described approach is computationally less complex and more flexible than conventional image processing detection techniques, such as template matching, enabling near real-time detections in cluttered images.

As described above, the object recognition system of the present invention may be used to recognize a target object using shape descriptors that are invariant (i.e., unaffected) by changes in tilt rotation. As further described above, the use of rotation invariant shape descriptors reduces the volume of three-dimensional space through which a target object must be rotated to generate a set of invariant shape descriptor value ranges capable of being used, as described above, to identify a target object based upon any arbitrary three dimensional rotation of the object.

An exemplary embodiment of the present invention may be configured to provide bomb squad units with the ability to automatically detect and highlight concealed blasting caps and other components associated with an improvised explosive device (IED) in images of x-rayed packages. For example, by automatically detecting and highlighting a potential blasting cap within X-ray imagery, the present invention helps to focus an operator upon areas of interest in order to find the other components of an explosive device, such as wires and batteries.

A characteristic shared by many conventional blasting caps is the use of a high density explosive filler with an oblong shape. Such high density explosive filler results in high intensity values in x-ray imagery, while other parts of the blasting cap can easily merge with the noise or clutter in the scene and become difficult to isolate as separate objects. Unfortunately, such an oblong shape is also common in other objects (e.g., pens, pencils, combs, etc.). The object recognition system of the present invention may be trained to detect blasting cap explosive filler by selecting a set of descriptors and weights based upon a training process, as described above, until an acceptable probability of detection and an acceptable probability of a false alarm is achieved.

For example, in one representative configuration, thirty-five descriptors were used to describe a representative blasting cap explosive filler and to distinguish the filler from similarly shaped objects within an image. The set of object descriptors included circularity, Fourier descriptors, moments, centroid, homogeneity, eccentricity, etc. Most of the chosen descriptors were made invariant to rotation, translation and scaling, as described above with respect to circularity, Fourier descriptors, and moments. Weights were generated for each descriptor based on statistics and behavior of the descriptors for different types of signal-to-noise ratio, complexity of scene, rotations, and aspect view.

FIG. 7A and FIG. 7B present performance measures for probabilities of detection (P_{D}) and probabilities of false alarms (PFA), respectively, for images processed using an exemplary embodiment of the object recognition system of the present invention using a set of descriptors selected and trained to detect a blasting cap explosive filler, as described above. The curves presented in FIG. 7A and FIG. 7B represent the median values obtained during training and test data for detection and false alarm probabilities. As shown in FIG. 7A and FIG. 7B, using a super-descriptor based upon a set of weighted descriptors and a threshold P_{D} value of 60%, a 100% probability of recognition for blasting cap target objects and a 0% probability of false alarms (i.e., incorrectly identifying a detected object as blasting cap explosive filler) may be achieved.

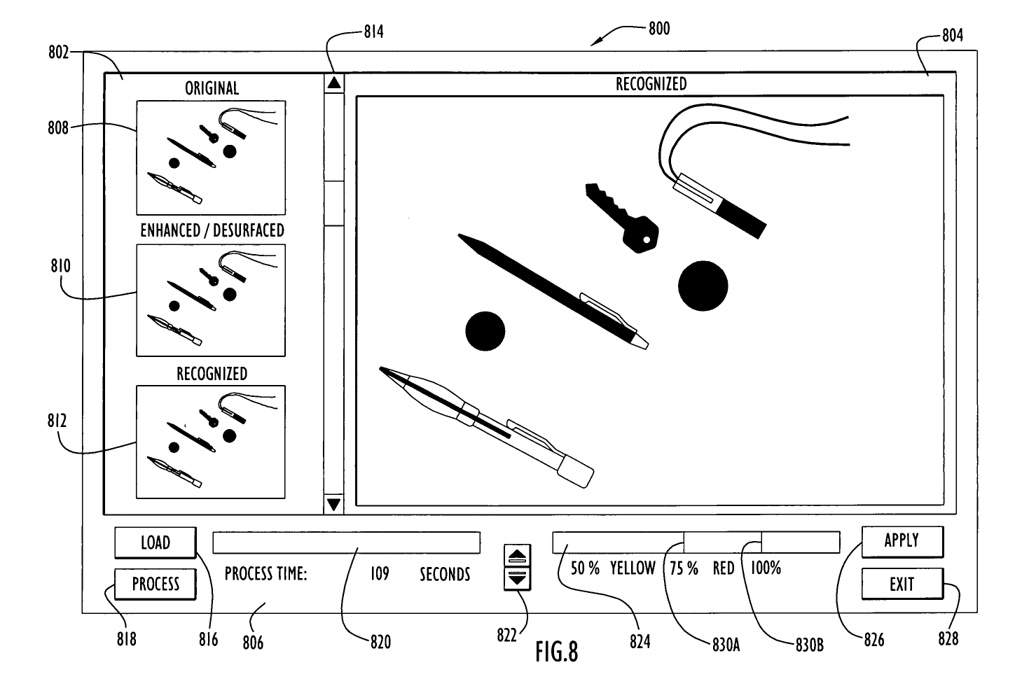

FIG. 8 presents an exemplary graphical user interface 800 for use by the object recognition system's user interface/controller module 104 (FIG. 1) to interact with an operator. In one embodiment, graphical user interface (GUI) 800 may include a thumbnail presentation area 802, an enlarged viewing area 804, and a toolbar 806. Thumbnail presentation area 802 may present small views of an image at various stages of processing each of which may be selected (i.e., clicked upon) to display a larger version of the selected image in enlarged viewing area 804. Toolbar 806 allows an operator to control the output generated by the object recognition process, described above.

For example, as shown in FIG. 8, thumbnail presentation area 802 may be configured to present a view of an original image 808 as received by the image recognition system, an enhanced/desurfaced view 810 of the original image, and a view of the enhanced image in which segmentation/object detection and object recognition 812 has been performed. An operator may configure thumbnail presentation area 802 to present any number and types of thumbnail images. For example, a user may configure thumbnail presentation area 802 to display an original image, an enhanced/desurfaced image, one or more generated threshold component images, a segmented/object composite image, and/or an image in which an object recognition process has been performed based upon any number of threshold probability of detection (P_{D}) values. An optional thumbnail scroll bar 814 is automatically added to thumbnail presentation area 802 if a greater number of thumbnails are requested than can fit within the thumbnail presentation area 802 at any one time.

Toolbar 806 allows an operator to control the output generated by the object recognition process, as described above. For example, as shown in FIG. 8, toolbar 806 may be configured to present a load button 816, a process button 818, a process status bar 820, an image selection bar 822, a select threshold probability of detection (P_{D}) bar 824, an apply selected P_{D} button 826, and/or an exit button 828.

Load button 816 allows an operator to load a saved image data file or receive a new image from an image generation system. Process button 818 may be used to initiate/reinitiate processing in order to generate/regenerate a currently selected thumbnail image. Process status bar 820 may be configured to present the status of a requested processing task. For example, upon an operator depressing process button 818, the status bar may initialize its color to red. As processing proceeds, the red segments may be incrementally replaced from left to right with green segments so that the number of green segments is proportional to the amount of elapsed time and the remaining number of red segments are proportion the amount of estimated remaining time. Image selection bar 822 may be clicked upon to update the image displayed in enlarged viewing area 804 based upon the thumbnail images presented in thumbnail presentation area 802. For example, an up-arrow portion of image selection bar 822 may be used to rotate through the set of thumbnail images in ascending order or a down-arrow portion of image selection bar 822 may be used to rotate through the set of thumbnail images in descending order.

Threshold probability of detection (P_{D}) selection bar 824, may be used to associate a color code with a range of one or more probability of detection (P_{D}) thresholds. For example, if probability of detection (P_{D}) selection bar 824 is configured to support three color codes (e.g., none, yellow, red), as shown in FIG. 8, thresholds associated with each color may be modified by the operator by clicking upon a separator 830 between any two color codes and dragging separator 830 to the left or to the right. For example, based upon the probability of detection (P_{D}) selection bar settings shown in FIG. 8, detected objects within a processed image with a Pⱼ(Object) between 0% and 50% will not be highlighted, detected objects within a processed image with a Pⱼ(Object) between 50% and 75% will be highlighted in yellow, and detected objects within a processed image with a Pⱼ(Object) between 75% and 100% will be highlighted in red. However, if separator 830A were dragged to the far side of left of probability of detection (P_{D}) selection bar 824 and separator 830B were dragged to the middle of probability of detection (P_{D}) selection bar 824, detected objects within a processed image with a Pⱼ(Object) between 0% and 50% will be highlighted in yellow, and detected objects within a processed image with a Pⱼ(Object) between 50% and 100% will be highlighted in red. Apply selected P_{D} button 826 is used to apply P_{D} values updated using detection (P_{D}) selection bar 824 to images containing detected objects. Upon clicking apply selected P_{D} button 826, objects images detected within images presented within thumbnail presentation area 802 and enlarged viewing area 804 are updated to reflect the newly assigned color codes. Clicking upon exit button 828 stores current user settings, saves currently displayed processed images and terminates graphical user interface 800. In this manner, an operator may quickly and easily adjust probability of detection display threshold levels to accommodate changes in operational needs. For example, in an image recognition system used to detect concealed weapons and explosives at a facility such as a U.S. Army base or an airport, probability of detection display values may be adjusted to a greater level of display sensitivity during periods of high operational threat and adjusted to a lower level of display sensitivity during periods of low operational threat.

As described above, thumbnail presentation area 802 may be configured to present a plurality of views. For example a thumbnail may present an original image 808 as received by the image recognition system, an enhanced/desurfaced view of the original image, one of several detected threshold component views, a composite view with detected objects, and a view in which recognized objects are highlighted, as described above. Each thumbnail image represents a view of the image presented in the preceding thumbnail image that has been subjected to an additional level of processing, as described above with respect to FIG. 3, FIG. 5, and FIG. 6. Upon selection of a thumbnail image, an operator may optionally update a set of default/user configurable parameters that control the processing performed to create the selected image from the preceding image. For example, by selecting an enhanced/desurfaced view of an image, an operator may update the quasi-Gausian model, initial sigma value, and/or the target signal-to-noise ratio used to generate the enhanced/desurfaced image from the original image. By selecting a threshold component or composite image with detected objects an operator may select and/or eliminate one or more threshold levels from the automatic threshold processing used to detect objects. By selecting an image with recognized objects, an operator may optionally add/eliminate an object descriptor, alter descriptor weights and/or manually modify the range of acceptable values for one or more descriptors. Upon saving the updated processing control parameters a user may select process button 818 to regenerate the selected thumbnail image based upon the new parameters.

It may be appreciated that the embodiments described above and illustrated in the drawings represent only a few of the many ways of applying target object descriptors within an object recognition system to recognize views of a target object within a generated image. The present invention is not limited to the specific embodiments disclosed herein and variations of the method and apparatus described here may be used to detect and recognize target objects within views using image processing techniques.

The object recognition system described here can be implemented in any number of units, or modules, and is not limited to any specific software module architecture. Each module can be implemented in any number of ways and are not limited in implementation to execute process flows precisely as described above. The object recognition system described above and illustrated in the flow charts and diagrams may be modified in any manner that accomplishes the functions described herein. It is to be understood that various functions of the object recognition system may be distributed in any manner among any quantity (e.g., one or more) of hardware and/or software modules or units, computer or processing systems or circuitry.

The object recognition system of the present invention is not limited to use in the analysis of any particular type of image generated by any particular imaging system, but may be used to identify target objects within an image generated by any imaging system and/or an image that is a composite of images generated by a plurality of image generators.

Target object descriptor sets may include any number and type of object descriptors. Descriptor sets may include descriptors based upon any characteristics of a target object detectable within a generated image view of the object including, but not limited to, shape, color, and size of a view of the object produced with any imaging technology or combination of correlated images using one or more images and/or imaging technologies. Further, descriptor sets may include descriptors based upon or derived from any detectable characteristics of a target object.

Nothing in this disclosure should be interpreted as limiting the present invention to any specific imaging technology. Nothing in this disclosure should be interpreted as requiring any specific manner of representing stored target object descriptor value ranges and/or assigned weights. Further, nothing in this disclosure should be interpreted as requiring any specific manner of assessing object descriptor values generated for a detected object or any specific manner of comparing the generated descriptor values with stored target object descriptor values and/or value ranges.

Nothing in this disclosure should be interpreted as limiting the type or nature of object descriptors used to describe a target object. Stored target object descriptors may include any combination of invariant and or variant descriptors. For example, a stored set of descriptors for a target object may include descriptors that are invariant to the object's translation (i.e., position), scale, and rotation (i.e., orientation) as well as descriptors that vary depending upon the object's translation, scale, and rotation.

An object recognition system may include stored target object descriptor values and/or value ranges for one, or any number of imaging technologies. Actual descriptors used to detect an object may be determined based upon static, user defined and/or automatically/dynamically determined parameters. Stored target object descriptors may be stored in any manner and associated with a target object in any manner.

The object recognition system may be executed within any available operating system that supports a command line and/or graphical user interface (e.g., Windows, OS/2, Unix, Linux, DOS, etc.). The object recognition system may be installed and executed on any operating system/hardware platform and may be performed on any quantity of processors within the executing system or device.

It is to be understood that the object recognition system may be implemented in any desired computer language and/or combination of computer languages, and could be developed by one of ordinary skill in the computer and/or programming arts based on the functional description contained herein and the flow charts illustrated in the drawings. Further, object recognition system units may include commercially available components tailored in any manner to implement functions performed by the object recognition system described here. Moreover, the object recognition system software may be available or distributed via any suitable medium (e.g., stored on devices such as CD-ROM and diskette, downloaded from the Internet or other network (e.g., via packets and/or carrier signals), downloaded from a bulletin board (e.g., via carrier signals), or other conventional distribution mechanisms).

The object recognition system may accommodate any quantity and any type of data files and/or databases or other structures and may store sets of target object descriptor values/value ranges in any desired file and/or database format (e.g., ASCII, binary, plain text, or other file/directory service and/or database format, etc.). Further, any references herein to software, or commercially available applications, performing various functions generally refer to processors performing those functions under software control. Such processors may alternatively be implemented by hardware or other processing circuitry. The various functions of the object recognition system may be distributed in any manner among any quantity (e.g., one or more) of hardware and/or software modules or units. Processing systems or circuitry, may be disposed locally or remotely of each other and communicate via any suitable communications medium (e.g., hardwire, wireless, etc.). The software and/or processes described above and illustrated in the flow charts and diagrams may be modified in any manner that accomplishes the functions described herein.

From the foregoing description it may be appreciated that the present invention includes a method and apparatus for object detection and recognition using image processing techniques that allows views of target objects within an image to be quickly and efficiently detected and recognized based upon a fault tolerant assessment of previously determine target object descriptor values/value ranges.

Having described preferred embodiments of a method and apparatus for object detection and recognition using image processing techniques, it is believed that other modifications, variations and changes may be suggested to those skilled in the art in view of the teachings set forth herein. It is therefore to be understood that all such variations, modifications and changes are believed to fall within the scope of the present invention as defined by the appended claims.

1. A method for recognizing a target object within an image, the method comprising:
(a) receiving a generated image containing a view of an object;
(b) processing the image to detect the object within the image;
(c) generating a value for a descriptor based upon at least one characteristic of the detected object;
(d) comparing the generated descriptor value to a stored value of the descriptor based upon a view of the target object to obtain a comparison result; and
(e) determining whether the detected object is a view of the target object based upon an assessment of the comparison result.

2. The method of claim 1, wherein step wherein (c) further includes:
(c.1) generating a value for each of a plurality of descriptors based upon the detected object; and
wherein (d) further includes:
(d.1) comparing each generated descriptor value to a value stored for the descriptor based upon a view of the target object to obtain a plurality of comparison results; and
(e) further includes:
(e.1) generating a value for a super-descriptor based upon the plurality of comparison results; and
(e.2) determining whether the detected object is a view of the target object based upon an assessment of the super descriptor value.

3. The method of claim 1, wherein (d) further includes:
(d.1) comparing the generated descriptor value to a plurality of values stored for the descriptor, wherein each of the plurality of stored values is based upon a view of the target object from a unique aspect view angle, thereby obtaining a plurality of comparison results for a plurality of target object aspect view angles; and
(e) further includes:
(e.1) generating a value for a super-descriptor based upon the plurality of comparison results obtained for the unique target object aspect view angles; and
(e.2) determining whether the detected object is a view of the target object based upon an assessment the target object aspect view angle super-descriptor value.

4. The method of claim 3, wherein (e. 1) further includes:
(e.1.1) generating a super descriptor in which at least one comparison result is weighted with an operator assigned weight.

5. The method of claim 3, wherein (e.2) further includes:
(e.2.1) determining that the detected object is a view of the target object based upon a comparison of the super-descriptor values to a predetermined threshold value.

6. The method of claim 1, wherein the target object is at least one of:
a shaped explosive charge; and
a weapon.

7. The method of claim 1, wherein the target object is an explosive filler in a blasting cap.

8. The method of claim 1, wherein the target object is at least one of:
a living tissue organ;
a living tissue tumor;
a biological organism; and
a chemical structure.

9. The method of claim 1, wherein the target object is at least one of:
a geological feature; and
an extra-terrestrial feature.

10. The method of claim 1, wherein the target object is at least one of:
a vehicle; and
a man-made structure.

11. The method of claim 1, wherein (c) further includes generating a rotation invariant descriptor.

12. The method of claim 1, wherein (c) further includes generating at least one of:
a translation invariant descriptor; and
a scale invariant descriptor.

13. The method of claim 1, wherein (c) further includes generating a combination of variant and invariant descriptors.

14. The method of claim 1, wherein (a) further includes:
(a.1) receiving a stored image from a storage repository.

15. The method of claim 1, wherein (a) further includes:
(a. 1) receiving an image from an image generator.

16. The method of claim 1, wherein (a) further includes:
(a.1) receiving an image that is a composite of images created by a plurality of image generators.

17. The method of claim 1, wherein (b) further includes:
(b.1) selecting a pixel intensity threshold value from the received image;
(b.2) generating a component image based upon the received image and the selected threshold value; and
(b.3) detecting an object within the generated component image.

18. The method of claim 17, wherein (b) further includes:
(b.4) combining component images in which an object is detected to create a composite image; and
(b.5) detecting an object within the generated composite image.

19. The method of claim 1, wherein (c) further includes generating a descriptor that describes an object characteristic related to at least one of:
a circularity of the object;
a Fourier representation of an object characteristic;
a moment of the object;
a centroid of the object;
a homogeneity of the object; and
an eccentricity of the object.

20. The method of claim 1, wherein (d) further includes:
(d.1) comparing the generated descriptor to a stored target object descriptor value range based upon a view of the target object.

21. The method of claim 1, wherein (d) further includes:
(d.1) determining whether the generated descriptor value is within a predetermined proximity to a stored target object descriptor value.

22. The method of claim 1, wherein (d) further includes:
(d.1) retrieving the stored value of the descriptor from an information base containing a stored descriptor value for a plurality of target objects.

23. The method of claim 1, wherein (d) further includes:
(d.1) retrieving the stored value of the descriptor from an information base containing a plurality of stored descriptor values for each of a plurality of target objects.

24. The method of claim 1, wherein (b) further includes:
(b.1) removing a background component from the image.

25. The method of claim 24, wherein (b.1) further includes:
(b.1.1) generating an approximation of the image background component;
(b.1.2) removing the generated background component approximation from the received image.

26. An apparatus for recognizing a target object within an image, comprising:
an image interface module to receive a generated image containing a view of an object;
an object detection module to detect the object within the image;
a generation module to generate a value for a descriptor based upon at least one characteristic of the detected object;
a comparison module to compare the generated descriptor value to a stored value of the descriptor based upon a view of the target object to obtain a comparison result; and
a controller module to determine whether the detected object is a view of the target object based upon an assessment of the comparison result.

27. The apparatus of claim 26, wherein the generation module is configured to generate a value for each of a plurality of descriptors based upon the detected object; and
wherein the comparison module is configured to compare each generated descriptor value to a stored value for the descriptor based upon a view of the target object to obtain a plurality of comparison results; and
the controller module further comprises;
a super-descriptor generation module to generate a value for a super-descriptor based upon the plurality of comparison results; and
a super-descriptor assessment module to determine whether the detected object is a view of the target object based upon an assessment of the super descriptor value.

28. The apparatus of claim 26, wherein the comparison module is configured to compare the generated descriptor value to a plurality of values stored for the descriptor, wherein each of the plurality of stored values is based upon a view of the target object from a unique aspect view angle, thereby obtaining a plurality of comparison results for a plurality of target object aspect view angles; and
the controller module further includes:
a super-descriptor generation module to generate a value for a super-descriptor based upon the plurality of comparison results obtained for the unique target object aspect view angles; and
a super-descriptor assessment module to determine whether the detected object is a view of the target object based upon an assessment the target object aspect view angle super descriptor value.

29. The apparatus of claim 26, wherein the target object is at least one of:
a shaped explosive charge; and
a weapon.

30. The apparatus of claim 26, wherein the target object is an explosive filler in a blasting cap.

31. The apparatus of claim 26, wherein the generation module is configured to generate a rotation invariant descriptor value.

32. The apparatus of claim 26, wherein the generation module is configured to generate at least on of:
a translation invariant descriptor value; and
a scale invariant descriptor value.

33. A program product apparatus having a computer readable medium with computer program logic recorded thereon for recognizing a target object within an image, said program product apparatus comprising:
an image interface module to receive a generated image containing a view of an object;
an object detection module to detect the object within the image;
a generation module to generate a value for a descriptor based upon at least one characteristic of the detected object;
a comparison module to compare the generated descriptor value to a stored value of the descriptor based upon a view of the target object to obtain a comparison result; and
a controller module to determine whether the detected object is a view of the target object based upon an assessment of the comparison result.

34. The program product of claim 33, wherein the generation module is configured to generate a value for each of a plurality of descriptors based upon the detected object; and
wherein the comparison module is configured to compare each generated descriptor value to a stored value for the descriptor based upon a view of the target object to obtain a plurality of comparison results; and
the controller module further comprises;
a super-descriptor generation module to generate a value for a super-descriptor based upon the plurality of comparison results; and
a super-descriptor assessment module to determine whether the detected object is a view of the target object based upon an assessment of the super descriptor value.

35. The program product of claim 33, wherein the comparison module is configured to compare the generated descriptor value to a plurality of values stored for the descriptor, wherein each of the plurality of stored values is based upon a view of the target object from a unique aspect view angle, thereby obtaining a plurality of comparison results for a plurality of target object aspect view angles; and
the controller module further includes:
a super-descriptor generation module to generate a value for a super-descriptor based upon the plurality of comparison results obtained for the unique target object aspect view angles; and
a super-descriptor assessment module to determine whether the detected object is a view of the target object based upon an assessment the target object aspect view angle super descriptor value.

36. The program product of claim 33, wherein the target object is at least one of:
a shaped explosive charge; and
a weapon.

37. The program product of claim 33, wherein the target object is an explosive filler in a blasting cap.

38. The program product of claim 33, wherein the generation module is configured to generate a rotation invariant descriptor value.

39. The program product of claim 33, wherein the generation module is configured to generate at least on of:
a translation invariant descriptor value; and
a scale invariant descriptor value.

40. A method for interacting with an operator via a graphical user interface to control processing of an image in a plurality of stages, the method comprising:
(a) displaying a plurality of thumbnail views, wherein each thumbnail view represents the image at one of prior to a stage of processing and subsequent to a stage of processing;
(b) displaying an enlarged view of an operator selected thumbnail image; and
(c) receiving input from the operator that is used to control at least one of how the image is processed during a stage and how the processed image is displayed;
wherein said processing of the image includes at least one of removing a background component from the image, detecting an object within the image and recognizing a target object within the image.

41. The method of claim 40, wherein (a) further includes:
(a.1) receiving input from the operator that determines a number of thumbnail views available for display.

42. The method of claim 41, wherein in (a.1) the number of thumbnail views available for display exceeds a number of thumbnail views that may be displayed simultaneously, and wherein
(a) further includes:
(a.2) allowing an operator to scroll through the number of thumbnail views available for display while displaying only the number of thumbnail views that may be displayed simultaneously.

43. The method of claim 42, wherein (b) further includes:
(b.1) updating the operator selected thumbnail to a thumbnail displayed as a result of operator scrolling and updating the enlarged view to display the updated operator selected thumbnail image.

44. The method of claim 40, wherein (b) further includes:
(b.1) visually identifying at least one of a detected object and a recognized object within the displayed enlarged view.

45. The method of claim 40, wherein (b) further includes:
(b.1) visually identifying a recognized object within the displayed enlarged view based upon a determined value for a target object probability of detection associated with the recognized object.

46. The method of claim 40, wherein (c) further includes:
(c.1) allowing an operator to change control parameters for a stage of image processing associated with an operator selected thumbnail image.

47. A graphical user interface for interacting with an operator to control processing of an image in a plurality of stages, the graphical user interface comprising:
a thumbnail module to display a plurality of thumbnail views of the image, wherein each thumbnail view represents the image at one of prior to a stage of processing and subsequent to a stage of processing;
a presentation module to display an enlarged view of an operator selected thumbnail image; and
a control module to receive input from the operator that is used to control at least one of how the image is processed during a stage and how the processed image is displayed;
wherein said processing of the image includes at least one of removing a background component from the image, detecting an object within the image and recognizing a target object within the image.

48. The graphical user interface of claim 47, wherein the thumbnail module further comprises:
a configuration module to receive input from the operator that determines a number of thumbnail views available for display.

49. The graphical user interface of claim 48, wherein the number of thumbnail views the configuration module may be configured to display may exceed a number of thumbnail views that may be displayed simultaneously, and wherein the thumbnail module further comprises:
a scroll module to allow an operator to scroll through the number of thumbnail views available for display while displaying only the number of thumbnail views that may be displayed simultaneously.

50. The graphical user interface of claim 49, wherein the presentation module further comprises:
a thumbnail scroll interface module to update the operator selected thumbnail to a thumbnail displayed as a result of operator scrolling and to update the enlarged view to display the updated operator selected thumbnail image.

51. The graphical user interface of claim 47, wherein the presentation module further comprises:
a highlight module to visually identify at least one of a detected object and a recognized object within the displayed enlarged view.

52. The graphical user interface of claim 47, wherein the presentation module further comprises:
a highlight module to visually identify a recognized object within the displayed enlarged view based upon a determined value for a target object probability of detection associated with the recognized object.

53. The graphical user interface of claim 47, wherein the configuration module further comprises:
a thumbnail interface module to allow an operator to change control parameters for a stage of image processing upon the operator selecting a thumbnail image associated with the stage of image processing for which control parameters are to be changed.

54. A method for removing a background component from an image, the method comprising:
(a) receiving an image;
(b) generating an approximation of the background component of the image based upon a standard deviation value;
(c) generating a signal-to-noise ratio based upon the generated approximation and the received image;
(d) subtracting the generated approximation from the received image upon determining that the signal-to-noise ratio is within a threshold range of a predetermined target value; and
(e) determining a new standard deviation value and repeating (b) through (d) upon determining that the signal-to-noise ratio exceeds the threshold range of the predetermined target value.

55. The method of claim 54, wherein (a) further includes:
(a.1) retrieving the image from one of a local base of stored information and a remote base of stored information.

56. The method of claim 54, wherein (a) further includes:
(a.1) receiving the image from an image generator.

57. The method of claim 54, wherein (b) further includes:
(b.1) generating the approximation based upon a quasi-Gaussian distribution.

58. The method of claim 54, wherein (b) further includes:
(b. 1) generating the approximation based upon a distribution other than a quasi-Gaussian distribution.

59. The method of claim 54, wherein in (d) the threshold range is 3 dB.

60. The method of claim 54, wherein in (d) the predetermined signal-to-noise target value is 35 dB.

61. An apparatus for removing a background component from an image, the apparatus comprising:
an interface module to receive an image;
an approximation module to generate an approximation of the background component of the received image based upon a standard deviation;
a signal-to-noise module to generate a signal-to-noise ratio based upon the generated approximation and the received image;
a desurfacing module to subtract the generated approximation from the received image upon determining that the signal-to-noise ratio is within a threshold range of a predetermined target value; and
a control module to determine a new standard deviation and to instruct the approximation module to generate a new approximation based upon the new standard deviation, upon determining that the signal-to-noise ratio exceeds the threshold range of the predetermined target value.

62. The apparatus of claim 61, wherein the interface module further comprises:
a retrieval module to retrieve the image from one of a local base of stored information and a remote base of stored information.

63. The apparatus of claim 61, wherein the interface module further comprises:
a reception module to receive the image from an image generator.

64. The apparatus of claim 61, wherein the approximation module further comprises:
a generator module to generate the approximation based upon a quasi-Gaussian distribution.

65. The apparatus of claim 61, wherein the approximation module further comprises:
a generator module to generate the approximation based upon a distribution other than a quasi-Gaussian distribution.

66. The apparatus of claim 61, wherein the desurfacing module is configured to use a threshold range of 3 dB.

67. The apparatus of claim 61, wherein the desurfacing module is configured to use a predetermined signal-to-noise target value of 35 dB.

68. A method for recognizing an explosive filler in a blasting cap within an image, the method comprising:
(a) receiving a generated image containing a view of an object;
(b) processing the image to detect the object within the image;
(c) generating a value for a descriptor based upon at least one characteristic of the detected object, including a shape of the detected object;
(d) comparing the generated descriptor value to a stored value of the descriptor to obtain a comparison result, wherein the stored value of the descriptor is aspect view angle dependent; and
(e) determining whether the detected object is a view of the explosive filler based upon an assessment of the comparison result.

69. The method of claim 68, wherein (d) further includes:
(d.1) comparing the generated descriptor value to a plurality of values stored for the descriptor, wherein each of the plurality of stored values is based upon a view of the explosive filler from a unique aspect view angle, thereby obtaining a plurality of comparison results for a plurality of explosive filler aspect view angles.

70. An apparatus for recognizing an explosive filler in a blasting cap within an image, comprising:
an image interface module to receive a generated image containing a view of an object;
an object detection module to detect the object within the image;
a generation module to generate a value for a descriptor based upon at least one characteristic of the detected object, including a shape of the detected object;
a comparison module to compare the generated descriptor value to a stored value of the descriptor to obtain a comparison result, wherein the stored value of the descriptor is aspect view angle dependent; and
a controller module to determine whether the detected object is a view of the explosive filler based upon an assessment of the comparison result.

71. The apparatus of claim 70, wherein the comparison module is configured to compare the generated descriptor value to a plurality of values stored for the descriptor, wherein each of the plurality of stored values is based upon a view of the explosive filler from a unique aspect view angle, thereby obtaining a plurality of comparison results for a plurality of explosive filler aspect view angles.
